(19) United States
(12) Patent Application Publication
(10) Pub. No.: US 2026/0292675 A1
(43) Pub. Date: Sep. 24, 2026

(54) IDLE/INACTIVITY MOBILITY PROCEDURE FOR TIMING RESILIENCY

(71) Applicant: Telefonaktiebolaget LM Ericsson (publ), Stockholm (SE)

(72) Inventors: Mattias BERGSTRÖM, SOLLENTUNA (SE); Richard TANO, STOCKHOLM (SE)

(73) Assignee: Telefonaktiebolaget LM Ericsson (publ), Stockholm (SE)

(21) Appl. No.: 19/472,966

(22) PCT Filed: Mar. 28, 2024
(86) PCT No.: PCT/SE2024/050283

§ 371 Date: Oct. 6, 2025

Related U.S. Application Data
(60) Provisional application No. 63/457,509, filed on Apr. 6, 2023.

(51) Int. Cl. H04W 48/20; H04W 48/16

(52) U.S. Cl. CPC H04W 48/20; H04W 48/16

(57) ABSTRACT

A communication device in a communications network can determine information about a cell of the communications network. The information can indicate whether the cell is providing timing related information. The communication device can further determine to associate with the cell based on the information. The communication device can further, responsive to determining to associate with the cell, associate with the cell.

### TECHNICAL FIELD

The present disclosure is related to wireless communication systems and more particularly to reporting error group consistency for joint carrier phase measurement reporting.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

The Third Generation Partnership Project (“3GPP”) has stated requirements for 5G systems to remain time resilient if there is a global navigation satellite system (“GNSS”) failure and for 5G systems to act as a backup and offer wireless and indoor-capable time synchronization service for other applications (e.g., financial and power grid systems).

It is unclear how a radio access network (“RAN”) and a 5G core (“5GC”) learn about 5G System (“5GS”) network timing synchronization status and inform UEs (e.g., application running on the UE), devices attached to the UE (e.g., that receive time information from 5GS), and application functions (“Afs”). It is also unclear how to report 5GS network timing synchronization status (such as divergence from UTC and 5GS network timing source degradation). It is also unclear whether additional information needs to be provided to UEs and AFs to inform about 5GS network timing synchronization status.

### SUMMARY

According to some embodiments, a method of operating a communication device in a communications network is provided. The method includes determining information about a cell of the communications network. The information indicates whether the cell is providing timing related information. The method further includes determining to associate with the cell based on the information. The method further includes, responsive to determining to associate with the cell, associating with the cell.

According to other embodiments, a method of operating a network node in a communications network has been provided. The method includes determining information about a cell of the communications network. The information indicating whether the cell is providing timing related information. The method further includes transmitting (330) an indication of the information to a communication device.

According to other embodiments, a communication device, network node, host, system, computer program, computer program product, or non-transitory computer readable medium is provided to perform one of the above methods.

Certain embodiments may provide one or more of the following technical advantages. In some embodiments, the UE can camp on cells that support the timing resiliency which can increase the possibility that the UE can use this service and hence some interruptions in this service can be avoided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a flow chart illustrating an example of operations performed by a communication device in accordance with some embodiments;

FIG. 3 is a flow chart illustrating an example of operations performed by a network node in accordance with some embodiments;

FIG. 4 is a block diagram of a communication system in accordance with some embodiments;

FIG. 5 is a block diagram of a user equipment in accordance with some embodiments;

FIG. 6 is a block diagram of a network node in accordance with some embodiments;

FIG. 7 is a block diagram of a host, which may be an embodiment of the host of FIG. 4, in accordance with some embodiments;

FIG. 8 is a block diagram of a virtualization environment in accordance with some embodiments; and

FIG. 9 shows a communication diagram of a host communicating via a network node with a user equipment over a partially wireless connection in accordance with some embodiments.

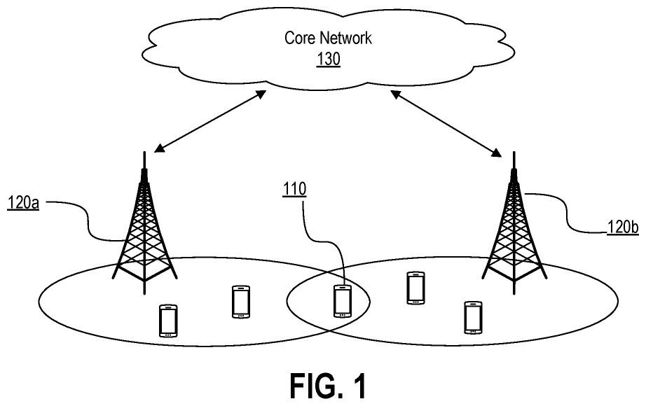

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. Some cells may support the timing resiliency feature while some cells may not. A UE which should get provided the timing resiliency feature would, according to current IDLE/INACTIVE mode mobility feature, connect to the best cell and that may result in the UE camping on a cell that does not provide the timing resiliency feature. As a result, the UE/device may be unable to do tasks that require the timing resiliency features, which may be expected of the UE/device.

Certain aspects of the disclosure and their embodiments may provide solutions to these or other challenges. Various embodiments herein determine if the UE should receive timing information from the network, and if so, the UE applies a modified IDLE/INACTIVE mobility procedure so that the UE stays on cells that can provide this service to the UE.

Various embodiments herein address how to provide a UE in a secure and resource efficient manner timing synchronization status.

In some examples, a status report is provided to UE via radio resource control (“RRC”) dedicated message when the UE is in a RRC_Connected state. This requires that to receive a status report, the UE must be in such state. The UEs that are in RRC Idle or RRC Inactive can determine whether the status of the time synchronization has changed and move to RRC_Connected mode in order to receive the status update.

In additional or alternative examples, Report ID can be included in a SIB9 message, which the UE can use as an index to select from a predefined and/or standardized list of time synchronization characteristics. The index can be known to a UE and its corresponding NG-RAN. This can allow the UE to determine by itself the status (or whether there is a need to Connect in order to get the status update) without the need to move into RRC_Connected. The status report can be provided in two ways: actual metrics of relevant time synchronization parameters, or an “acceptable/not acceptable” message.

Timing related information is a term used herein to refer to clock characteristics such as accuracy or class. A cell supporting the timing resiliency feature can provide timing related information. When a UE is in CONNECTED mode, the gNB can be in control of which cell(s) the UE is connected to. When the UE is in IDLE or INACTIVE, the UE may perform cell (re)selection to in general camp on the “best” cell from a signal strength point of view.

Embodiments associated with a modified IDLE/INACTIVE mode procedure are described below.

In some embodiments, a UE determines whether it should receive timing related information from the network. If it should, the UE will, during IDLE/INACTIVE mobility, apply a modified mobility procedure.

In additional or alternative embodiments, the modified mobility procedure may be a procedure to prioritize associating itself with cells that are providing (or can provide) the timing information. In some examples, to prioritize cells, the UE can prefer associating itself with a cell that provides the information in response to the UE detecting both cells that provide the information and cells that do not. In additional or alternative examples, a UE may only associate itself with cells that are providing (or can provide) the timing information.

In additional or alternative examples, the UE may be in a situation where the UE detects a cell that is providing the information, but that cell may not be suitable for other reasons (e.g., the signal quality/strength is below a threshold value, or the cell is barred). The UE may deviate from the prioritization rule and may anyway select a cell that does not provide the timing related information.

In additional or alternative examples, the term “associate” is used to refer to a UE camping on a cell.

In some embodiments, the UE may determine that it should receive timing related information based on: 1) services that are active; 2) subscription information of the UE; 3) capabilities of the UE; and/or 4) configuration from the network.

In some examples, some services may require the timing related information while some services may not require this information. The UE may determine that it should receive the timing related information only when services that need this timing related information are active.

In additional or alternative examples, the UE itself may be capable of receiving the timing related information, but the UE's subscription may not allowing/indicating that the UE should receive such information. The UE may only apply the modified mobility procedure if the subscription indicates that the UE should/can do so. The UE (or device in general terms) may have multiple subscriptions (e.g. multiple SIMs) and in that case the UE may apply one behavior when considering one SIM and another when considering another SIM. For example, a UE may have a subscription/SIM for Operator A and another subscription/SIM for Operator B, and the UE may then apply one behavior in Operator A's network where it may be having a subscription allowing the UE to receive the timing information, while another behavior in Operator B's network where it is not allowed to receive the timing information.

In additional or alternative examples, the UE (e.g., the chipset in the UE) may not have the necessary functionality to receive the timing related information. The UE may be operating such that it would only apply the modified mobility procedure if the UE is capable (has the necessary functionality) to receive the timing related information.

In additional or alternative examples, the UE may consider that it is configured to receive timing related information if a RAN-node indicated that the UE shall receive such information and/or a core network-node indicated that the UE shall receive such information.

In some embodiments, the UE may determine if a first cell is providing (or can provide) the timing information based on an indication(s) from the first cell (e.g., indication(s) in a broadcast channel). The indication(s) may be carried in system information. In some examples, the indication indicates which timing information is currently applicable in the cell. Absence of such indication(s) may be interpreted as the cell is not providing (or cannot provide) the timing information.

In additional or alternative embodiments, the UE can determine if a first cell is providing (or can provide) the timing information based on an indication(s) received from a second cell. The first and second cell may be neighboring cells. The second cell may for example have information relating its neighbor cells (one of them being the first cell) and for those neighboring cells the second cell may indicate if they are providing the timing related information. This could for example be implemented as a list in system information from the second cell where the cells in that list are providing the timing related information, and cells which are not present in this list are not providing the timing related information.

In additional or alternative embodiments, the UE can determine if a first cell is providing (or can provide) the timing information based on which frequency the cell is on. For example, the UE may determine that all cells on a frequency 1 provides the timing related information. The UE would then consider a frequency wherein the cells provide the timing related information to be higher priority than cells on a frequency where the cells do not provide the timing related information.

In some embodiments, the cells that are supporting the timing resiliency feature may also provide an indication that specify the level of timing information. For example, the level of timing information can give an indication of how accurate a clock accuracy is or how often a degradation in accuracy happen. The level can be of different values (e.g., high, medium, and low). A high level may support UEs with very strict requirement on timing information while a lower level may not be able to support all UEs.

In additional or alternative embodiments, the UE can take into account this indication when deciding which cells are suitable to associate with. A level of timing information the UE determines is needed may depend on the services active, subscription information, capabilities of the UE, and/or configuration from the network. If a certain level is deemed preferred the UE may prioritize associating itself with the cells that provide at least such level of timing information.

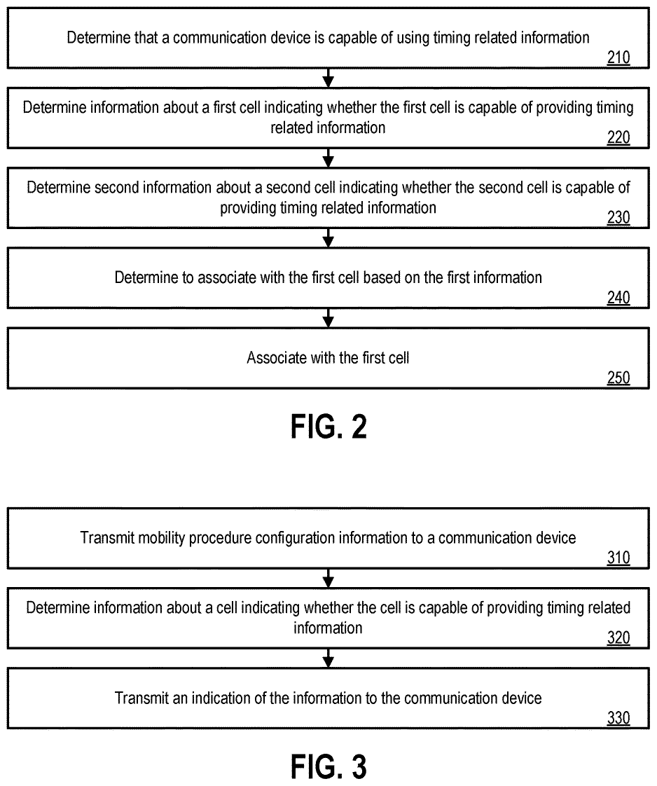

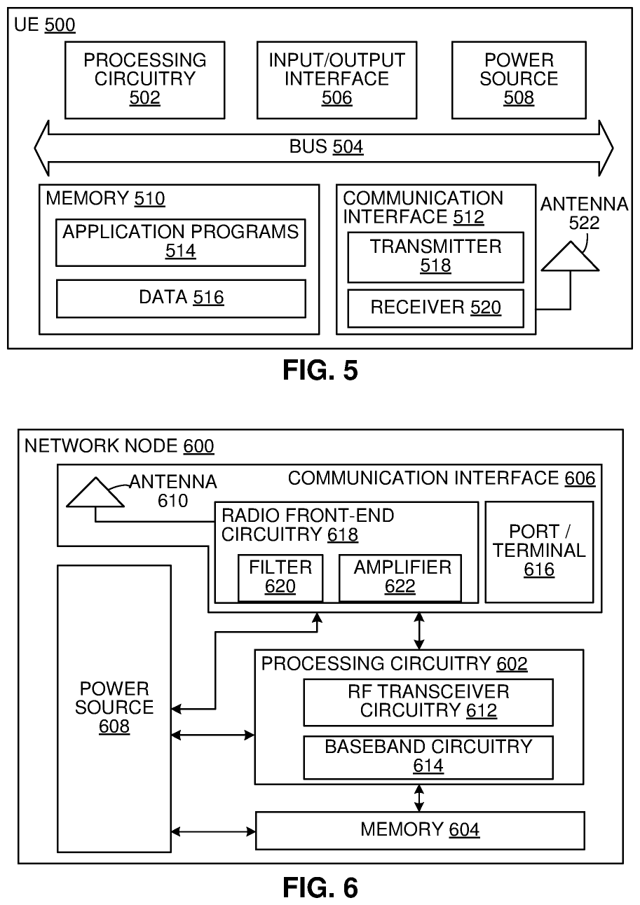

Operations of the communication device 500 (implemented using the structure of the block diagram of FIG. 5) will now be discussed with reference to the flow chart of FIG. 2 according to some embodiments of inventive concepts. For example, modules may be stored in memory 510 of FIG. 5, and these modules may provide instructions so that when the instructions of a module are executed by respective communication device processing circuitry 502, processing circuitry 502 performs respective operations of the flow chart.

FIG. 2 illustrates an example of operations performed by a communication device in accordance with some embodiments.

At block 210, processing circuitry 502 determines that the communication device is capable of using timing related information. In some embodiments, determining that the communication device is capable of using the timing related information includes determining that the communication device is capable of using the timing related information based on at least one of: a service that is active on the communication device; a service that is available on the communication device; a subscription associated with the communication device; a capability of the communication device; and configuration information provided by the communications network.

In some examples, timing related information is a term used to refer to clock characteristics such as accuracy or class. When a UE is in a RRC_CONNECTED state it should be able to receive clock quality information. The clock quality should be delivered through a RRC dedicated message. The clock quality information can include different information. The information can include clock quality metrics reflecting RANs current timing synchronization status, which can include clock accuracy, PTP clockClass, traceability to UTC, frequency stability, time source, synchronization state. The information can also include clock quality detail level which provides an acceptable indication to the UE if the RAN's timing synchronization status matches the acceptance criteria received from AMF.

At block 220, processing circuitry 502 determines information about a cell of the communications network, the information indicating whether the cell is capable of providing timing related information. In some embodiments, determining the information includes determining the information in response to determining that the communication device is capable of using the timing related information.

In additional or alternative embodiments, the information further indicates at least one of: that the cell is capable of providing the timing related information; whether the cell is providing the timing related information; and an accuracy of the timing related information provided by the cell.

At block 230, processing circuitry 502 determines second information about a second cell of the communications network. The second information indicating whether the second cell is capable of providing timing related information.

At block 240, processing circuitry 502 determines to associate with the cell based on the information. In some embodiments, determining to associate with the cell includes determining to associate with the cell while the communication device is in a radio resource control, RRC, idle state or a RRC inactive state.

In additional or alternative embodiments, determining that the communication device is capable of using the timing related information includes determining an importance of using the timing related information. Determining to associate with the cell includes determining to associate with the cell based on the importance of using the timing related information.

In additional or alternative embodiments, determining to associate with the first cell includes determining to associate with the first cell rather than the second cell based on the first information and the second information.

In some examples, the first information includes an indication that the first cell is capable of providing the timing related information. The second information includes an indication that the second cell is not capable of providing the timing related information.

Determining to associate with the first cell rather than the second cell includes determining to associate with the first cell rather than the second cell based on the first cell being capable of providing the timing related information and the second cell not being capable of providing the timing related information.

In additional or alternative examples, determining to associate with the first cell rather than the second cell includes determining a first characteristic of the first cell. The first characteristic being separate from the capability of the first cell to provide timing related information. Determining a second characteristic of the second cell. The second characteristic being separate from the capability of the second cell to provide timing related information.

Determining a threshold difference based on the first cell being capable of providing the timing related information and the second cell not being capable of providing the timing related information. Determining that a difference between the second characteristic and the first characteristic is less than the threshold difference. Determining to associate with the first cell rather than the second cell based on the difference being less than the threshold difference. In additional or alternative examples, the first information includes an indication that the first cell is providing the timing related information. The second information includes an indication that the second cell is not providing the timing related information. Determining to associate with the first cell rather than the second cell includes determining to associate with the first cell rather than the second cell based on the first cell providing the timing related information and the second cell not providing the timing related information.

In additional or alternative examples, determining to associate with the first cell rather than the second cell determining a first characteristic of the first cell. The first characteristic being separate from the capability of the first cell to provide timing related information. Determining a second characteristic of the second cell. The second characteristic being separate from the capability of the second cell to provide timing related information.

Determining a threshold difference based on the first cell providing the timing related information and the second cell not providing the timing related information. Determining that a difference between the second characteristic and the first characteristic is less than the threshold difference. Determining to associate with the first cell rather than the second cell based on the difference being less than the threshold difference. In additional or alternative examples, the first information includes an indication of a first accuracy of timing related information provided by the first cell. The second information includes an indication of a second accuracy of timing related information provided by the second cell. Determining to associate with the first cell rather than the second cell includes determining to associate with the first cell rather than the second cell based on the first accuracy being greater than the second accuracy.

In additional or alternative examples, determining to associate with the first cell rather than the second cell includes determining a first characteristic of the first cell, the first characteristic being separate from the capability of the first cell to provide timing related information. Determining a second characteristic of the second cell, the second characteristic being separate from the capability of the second cell to provide timing related information.

Determining a threshold difference based on the first accuracy and the second accuracy.

Determining that a difference between the second characteristic and the first characteristic is less than the threshold difference. Determining to associate with the first cell rather than the second cell based on the difference being less than the threshold difference.

In additional or alternative examples, the first information includes an indication that the first cell is not capable of providing the timing related information. The second information includes an indication that the second cell is capable of providing the timing related information. Determining to associate with the first cell rather than the second cell includes: determining a first characteristic of the first cell, the first characteristic being separate from the capability of the first cell to provide timing related information; determining a second characteristic of the second cell, the second characteristic being separate from the capability of the second cell to provide timing related information; determining a threshold difference based on the first cell not being capable of providing the timing related information and the second cell being capable of providing the timing related information; determining that the difference between the second characteristic and the first characteristic is greater than the threshold difference; and determining to associate with the first cell rather than the second cell based on the difference being greater than the threshold difference.

In additional or alternative examples, the first information includes an indication that the first cell is not providing the timing related information. The second information includes an indication that the second cell is providing the timing related information. Determining to associate with the first cell rather than the second cell includes: determining a first characteristic of the first cell, the first characteristic being separate from the capability of the first cell to provide timing related information; determining a second characteristic of the second cell, the second characteristic being separate from the capability of the second cell to provide timing related information; determining a threshold difference based on the first cell not providing the timing related information and the second cell providing the timing related information; determining that the difference between the second characteristic and the first characteristic is greater than the threshold difference; and determining to associate with the first cell rather than the second cell based on the difference being greater than the threshold difference.

In additional or alternative examples, the first information includes an indication of a first accuracy of timing related information provided by the first cell. The second information includes an indication of a second accuracy of timing related information provided by the second cell, the second accuracy being greater than the first accuracy. Determining to associate with the first cell rather than the second cell includes: determining a first characteristic of the first cell, the first characteristic being separate from the capability of the first cell to provide timing related information; determining a second characteristic of the second cell, the second characteristic being separate from the capability of the second cell to provide timing related information; determining a threshold difference based on the first accuracy and the second accuracy; determining that the difference between the second characteristic and the first characteristic is greater than the threshold difference; and determining to associate with the first cell rather than the second cell based on the difference being greater than the threshold difference.

In additional or alternative examples, the first characteristic and the second characteristic each include at least one of: a reference signal received quality, RSRQ, measurement; a reference signal received power, RSRP, measurement; and a signal-to-interference-to-noise, SINR, measurement.

In additional or alternative examples, determining the threshold difference further includes determining the threshold difference based on an importance of using the timing related information to the communication device.

In additional or alternative embodiments, determining the information about the cell includes receiving the information from the cell via a broadcast channel or a system information block.

In additional or alternative embodiments, determining the information about the cell includes receiving the information from a neighboring cell to the cell.

In additional or alternative embodiments, determining the information about the cell includes determining the information based on a frequency used by the cell.

At block 250, processing circuitry 502 associates with the cell. In some embodiments, associating with the cell includes camping on the cell.

Various operations from the flow chart of FIG. 2 may be optional with respect to some embodiments of communication devices and related methods.

Operations of the RAN node 600 (implemented using the structure of FIG. 6) will now be discussed with reference to the flow chart of FIG. 3 according to some embodiments of inventive concepts. For example, modules may be stored in memory 604 of FIG. 6, and these modules may provide instructions so that when the instructions of a module are executed by respective RAN node processing circuitry 602, RAN node 600 performs respective operations of the flow chart.

FIG. 3 illustrates an example of operations performed by a network node in a communications network.

At block 310, processing circuitry 602 transmits, via communication interface 606, mobility procedure configuration information to the communication device. The mobility procedure configuration information indicates that the communication device will determine which cell of the communication network to attach to based on each cells capability to provide timing related information.

At block 320, processing circuitry 602 determines information about a cell of the communications network. The information can indicate whether the cell is capable of providing timing related information. In some embodiments, the network node is configured to provide the cell. In additional or alternative embodiments, the network node is configured to provide a neighboring cell of the cell.

In additional or alternative embodiments, the information further indicates at least one of: that the cell is capable of providing the timing related information; whether the cell is providing the timing related information; and an accuracy of the timing related information provided by the cell.

At block 330, processing circuitry 602 transmits, via communication interface 606, an indication of the information to a communication device.

Various operations from the flow chart of FIG. 3 may be optional with respect to some embodiments of RAN nodes and related methods.

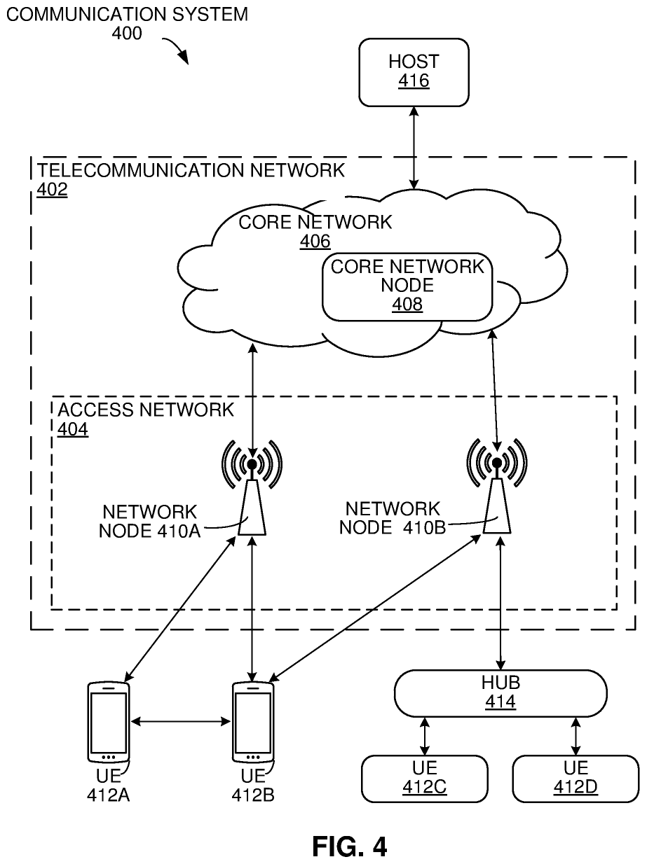

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access node or non-3GPP access point. Moreover, as will be appreciated by those of skill in the art, the network nodes 410 are not necessarily limited to an implementation in which a radio portion and a baseband portion are supplied and integrated by a single vendor. Thus, it will be understood that the network nodes 410 may include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 410 facilitate direct or indirect connection of user equipment (UE), such as by connecting wireless devices 412a, 412b, 412c, and 412d (one or more of which may be generally referred to as UEs 412) to the core network 406 over one or more wireless connections. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub-that is, a hub whose primary function is to route communications to/from the UEs from/to the network node 410b. In other embodiments, the hub 414 may be a non-dedicated hub-that is, a device which is capable of operating to route communications between the UEs and network node 410b, but which is additionally capable of operating as a communication start and/or end point for certain data channels.

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508.

Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

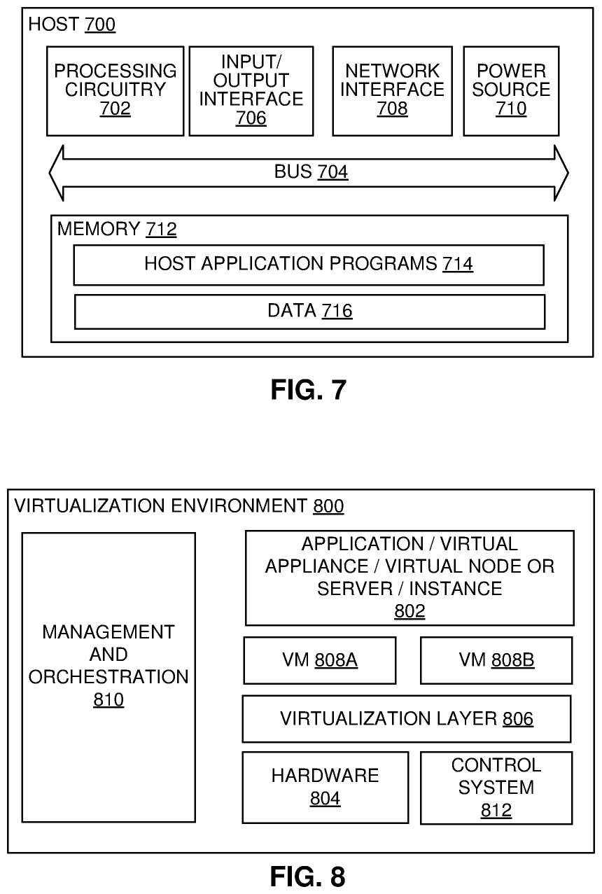

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 800 includes components defined by the O-RAN Alliance, such as an O-Cloud environment orchestrated by a Service Management and Orchestration Framework via an O-2 interface.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

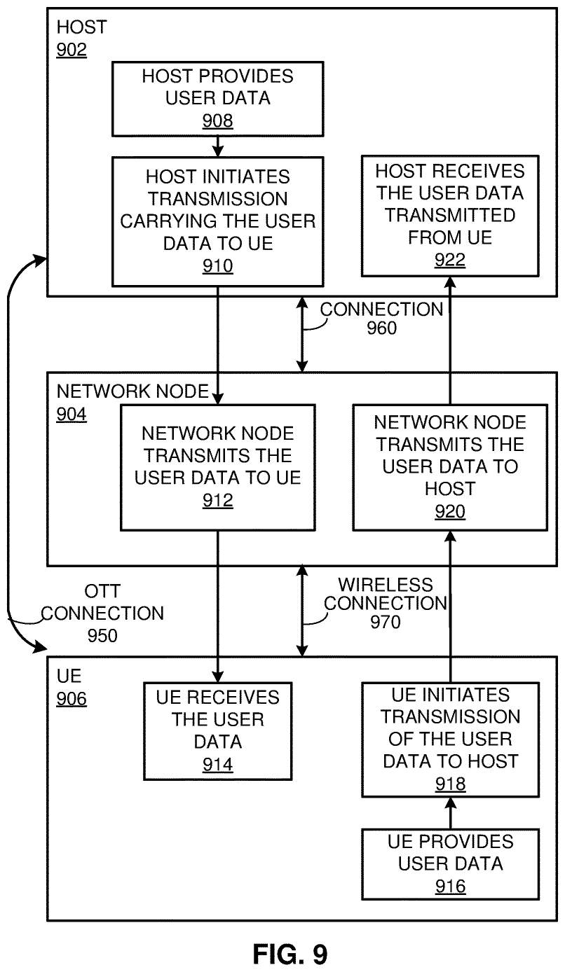

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may allow a UE to camp on a cell that supports timing resiliency, which can increase the chance that a UE can perform operations that requires timing related information. This can improve user experience, prevent desynchronization, and reduce synchronization overhead.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A method of operating a communication device in a communications network, the method comprising:
determining (220) information about a cell of the communications network, the information indicating whether the cell is capable of providing timing related information;
determining (240) to associate with the cell based on the information; and
responsive to determining to associate with the cell, associating (250) with the cell.

Embodiment 2. The method of Embodiment 1, wherein associating with the cell comprises camping on the cell.

Embodiment 3. The method of any of Embodiments 1-2, wherein determining to associate with the cell comprises determining to associate with the cell while the communication device is in a radio resource control, RRC, idle state or a RRC inactive state.

Embodiment 4. The method of any of Embodiments 1-3, further comprising:
determining (210) that the communication device is capable of using the timing related information,
wherein determining the information comprises determining the information in response to determining that the communication device is capable of using the timing related information.

Embodiment 5. The method of Embodiment 4, wherein determining that the communication device is capable of using the timing related information comprises determining that the communication device is capable of using the timing related information based on at least one of:
a service that is active on the communication device;
a service that is available on the communication device;
a subscription associated with the communication device;
a capability of the communication device; and
configuration information provided by the communications network.

Embodiment 6. The method of any of Embodiments 4-5, wherein determining that the communication device is capable of using the timing related information comprises determining an importance of using the timing related information, and
wherein determining to associate with the cell comprises determining to associate with the cell based on the importance of using the timing related information.

Embodiment 7. The method of any of Embodiments 1-6, wherein the information further indicates at least one of:
that the cell is capable of providing the timing related information;
whether the cell is providing the timing related information; and
an accuracy of the timing related information provided by the cell.

Embodiment 8. The method of any of Embodiments 1-7, wherein the information comprises first information,
wherein the cell comprises a first cell,
the method further comprising:
   determining (230) second information about a second cell of the communications network, the second information indicating whether the second cell is capable of providing timing related information,
   wherein determining to associate with the first cell comprises determining to associate with the first cell rather than the second cell based on the first information and the second information.

Embodiment 9. The method of Embodiment 8, wherein the first information comprises an indication that the first cell is capable of providing the timing related information,
wherein the second information comprises an indication that the second cell is not capable of providing the timing related information, and
wherein determining to associate with the first cell rather than the second cell comprises determining to associate with the first cell rather than the second cell based on the first cell being capable of providing the timing related information and the second cell not being capable of providing the timing related information.

Embodiment 10. The method of Embodiment 9, wherein determining to associate with the first cell rather than the second cell comprises:

determining a first characteristic of the first cell, the first characteristic being separate from the capability of the first cell to provide timing related information
determining a second characteristic of the second cell, the second characteristic being separate from the capability of the second cell to provide timing related information;
determining a threshold difference based on the first cell being capable of providing the timing related information and the second cell not being capable of providing the timing related information;
determining that a difference between the second characteristic and the first characteristic is less than the threshold difference; and
determining to associate with the first cell rather than the second cell based on the difference being less than the threshold difference.

Embodiment 11. The method of Embodiment 8, wherein the first information comprises an indication that the first cell is providing the timing related information,
wherein the second information comprises an indication that the second cell is not providing the timing related information, and
wherein determining to associate with the first cell rather than the second cell comprises determining to associate with the first cell rather than the second cell based on the first cell providing the timing related information and the second cell not providing the timing related information.

Embodiment 12. The method of Embodiment 11, wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first cell providing the timing related information and the second cell not providing the timing related information;
determining that a difference between the second characteristic and the first characteristic is less than the threshold difference; and
determining to associate with the first cell rather than the second cell based on the difference being less than the threshold difference.

Embodiment 13. The method of Embodiment 8, wherein the first information comprises an indication of a first accuracy of timing related information provided by the first cell;
wherein the second information comprises an indication of a second accuracy of timing related information provided by the second cell;
wherein determining to associate with the first cell rather than the second cell comprises determining to associate with the first cell rather than the second cell based on the first accuracy being greater than the second accuracy.

Embodiment 14. The method of Embodiment 13, wherein determining to associate with the first cell rather than the second cell comprises:
determining a first characteristic of the first cell, the first characteristic being separate from the capability of the first cell to provide timing related information
determining a second characteristic of the second cell, the second characteristic being separate from the capability of the second cell to provide timing related information;
determining a threshold difference based on the first accuracy and the second accuracy;
determining that a difference between the second characteristic and the first characteristic is less than the threshold difference; and
determining to associate with the first cell rather than the second cell based on the difference being less than the threshold difference.

Embodiment 15. The method of Embodiment 8, wherein the first information comprises an indication that the first cell is not capable of providing the timing related information,
wherein the second information comprises an indication that the second cell is capable of providing the timing related information, and
wherein determining to associate with the first cell rather than the second cell comprises:
   determining a first characteristic of the first cell, the first characteristic being separate from the capability of the first cell to provide timing related information
   determining a second characteristic of the second cell, the second characteristic being separate from the capability of the second cell to provide timing related information;
   determining a threshold difference based on the first cell not being capable of providing the timing related information and the second cell being capable of providing the timing related information;
   determining that the difference between the second characteristic and the first characteristic is greater than the threshold difference; and
   determining to associate with the first cell rather than the second cell based on the difference being greater than the threshold difference.

Embodiment 16. The method of Embodiment 8, wherein the first information comprises an indication that the first cell is not providing the timing related information,
wherein the second information comprises an indication that the second cell is providing the timing related information, and
wherein determining to associate with the first cell rather than the second cell comprises:
   determining a first characteristic of the first cell, the first characteristic being separate from the capability of the first cell to provide timing related information;
   determining a second characteristic of the second cell, the second characteristic being separate from the capability of the second cell to provide timing related information;
   determining a threshold difference based on the first cell not providing the timing related information and the second cell providing the timing related information;
   determining that the difference between the second characteristic and the first characteristic is greater than the threshold difference; and
   determining to associate with the first cell rather than the second cell based on the difference being greater than the threshold difference.

Embodiment 17. The method of Embodiment 8, wherein the first information comprises an indication of a first accuracy of timing related information provided by the first cell;
wherein the second information comprises an indication of a second accuracy of timing related information provided by the second cell, the second accuracy being greater than the first accuracy;
wherein determining to associate with the first cell rather than the second cell comprises:
   determining a first characteristic of the first cell, the first characteristic being separate from the capability of the first cell to provide timing related information;
   determining a second characteristic of the second cell, the second characteristic being separate from the capability of the second cell to provide timing related information;
   determining a threshold difference based on the first accuracy and the second accuracy;
   determining that the difference between the second characteristic and the first characteristic is greater than the threshold difference; and
   determining to associate with the first cell rather than the second cell based on the difference being greater than the threshold difference.

Embodiment 18. The method of any of Embodiments 10-17, wherein the first characteristic and the second characteristic each comprise at least one of:
a reference signal received quality, RSRQ, measurement;
a reference signal received power, RSRP, measurement; and
a signal-to-interference-to-noise, SINR, measurement.

Embodiment 19. The method of any of Embodiments 10-18, wherein determining the threshold difference further comprises determining the threshold difference based on an importance of using the timing related information to the communication device.

Embodiment 20. The method of any of Embodiments 1-19, wherein determining the information about the cell comprises receiving the information from the cell via a broadcast channel or a system information block.

Embodiment 21. The method of any of Embodiments 1-20, wherein determining the information about the cell comprises receiving the information from a neighboring cell to the cell.

Embodiment 22. The method of any of Embodiments 1-21, wherein determining the information about the cell comprises determining the information based on a frequency used by the cell.

Embodiment 23. A method of operating a network node in a communications network, the method comprising:
determining (320) information about a cell of the communications network, the information indicating whether the cell is capable of providing timing related information; and
transmitting (330) an indication of the information to a communication device.

Embodiment 24. The method of Embodiment 23, wherein the network node is configured to provide the cell.

Embodiment 25. The method of Embodiment 24, wherein the network node is configured to provide a neighboring cell of the cell.

Embodiment 26. The method of any of Embodiments 23-25, wherein the information further indicates at least one of:
that the cell is capable of providing the timing related information;
whether the cell is providing the timing related information; and
an accuracy of the timing related information provided by the cell.

Embodiment 27. The method of any of Embodiments 23-26, further comprising:
transmitting (310) mobility procedure configuration information to the communication device, the mobility procedure configuration information indicating that the communication device will determine which cell of the communication network to attach to based on each cells capability to provide timing related information.

Embodiment 28. A communication device (500), the communication device comprising:
processing circuitry (502); and
memory (510) coupled to the processing circuitry and having instructions stored therein that are executable by the processing circuitry to cause the communication device to perform operations comprising any of the operations of Embodiments 1-22.

Embodiment 29. A computer program comprising program code to be executed by processing circuitry (502) of a communication device (500), whereby execution of the program code causes the communication device to perform operations comprising any operations of Embodiments 1-22.

Embodiment 30. A computer program product comprising a non-transitory storage medium (510) including program code to be executed by processing circuitry (502) of a communication device (500), whereby execution of the program code causes the entity to perform operations comprising any operations of Embodiments 1-22.

Embodiment 31. A non-transitory computer-readable medium having instructions stored therein that are executable by processing circuitry (502) of a communication device (500) to cause the communication device to perform operations comprising any of the operations of Embodiments 1-22.

Embodiment 32. A network node (600), the network node comprising:
processing circuitry (602); and
memory (604) coupled to the processing circuitry and having instructions stored therein that are executable by the processing circuitry to cause the network node to perform operations comprising any of the operations of Embodiments 23-27.

Embodiment 33. A computer program comprising program code to be executed by processing circuitry (602) of a network node (600), whereby execution of the program code causes the network node to perform operations comprising any operations of Embodiments 23-27.

Embodiment 34. A computer program product comprising a non-transitory storage medium (604) including program code to be executed by processing circuitry (602) of a network node (600), whereby execution of the program code causes the network node to perform operations comprising any operations of Embodiments 23-27.

Embodiment 35. A non-transitory computer-readable medium having instructions stored therein that are executable by processing circuitry (602) of a network node (600) to cause the network node to perform operations comprising any of the operations of Embodiments 23-27.

Embodiment 36. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   determining (320) information about a cell of the communications network, the information indicating whether the cell is capable of providing timing related information; and
   transmitting (330) an indication of the information to a communication device.

Embodiment 37. The host of the previous embodiment, wherein:
the processing circuitry of the host is configured to execute a host application that provides the user data; an
the UE comprises processing circuitry configured to execute a client application associated with the host application to receive the transmission of user data from the host.

Embodiment 38. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   determining (320) information about a cell of the communications network, the information indicating whether the cell is capable of providing timing related information; and
   transmitting (330) an indication of the information to a communication device.

Embodiment 39. The method of the previous embodiment, further comprising, at the network node, transmitting the user data provided by the host for the UE.

Embodiment 40. The method of any of the previous 2 embodiments, wherein the user data is provided at the host by executing a host application that interacts with a client application executing on the UE, the client application being associated with the host application.

Embodiment 41. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   determining (320) information about a cell of the communications network, the information indicating whether the cell is capable of providing timing related information; and
   transmitting (330) an indication of the information to a communication device.

Embodiment 42. The communication system of the previous embodiment, further comprising:
the network node; and/or
the user equipment.

Embodiment 43. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 44. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   determining (320) information about a cell of the communications network, the information indicating whether the cell is capable of providing timing related information; and
   transmitting (330) an indication of the information to a communication device.

Embodiment 45. The host of the previous 2 embodiments, wherein:
the processing circuitry of the host is configured to execute a host application, thereby providing the user data; and
the host application is configured to interact with a client application executing on the UE, the client application being associated with the host application.

Embodiment 46. The host of the any of the previous 2 embodiments, wherein the initiating receipt of the user data comprises requesting the user data.

Embodiment 47. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   determining (320) information about a cell of the communications network, the information indicating whether the cell is capable of providing timing related information; and
   transmitting (330) an indication of the information to a communication device.

Embodiment 48. The method of the previous embodiment, further comprising at the network node, transmitting the received user data to the host.

Embodiment 49. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   determining (220) information about a cell of the communications network, the information indicating whether the cell is capable of providing timing related information;
   determining (240) to associate with the cell based on the information; and
   responsive to determining to associate with the cell, associating (250) with the cell.

Embodiment 50. The host of the previous embodiment, wherein the cellular network further includes a network node configured to communicate with the UE to transmit the user data to the UE from the host.

Embodiment 51. The host of the previous 2 embodiments, wherein:
the processing circuitry of the host is configured to execute a host application, thereby providing the user data; and
the host application is configured to interact with a client application executing on the UE, the client application being associated with the host application.

Embodiment 52. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
   determining (220) information about a cell of the communications network, the information indicating whether the cell is capable of providing timing related information;
   determining (240) to associate with the cell based on the information; an
   responsive to determining to associate with the cell, associating (250) with the cell.

Embodiment 53. The method of the previous embodiment, further comprising:
at the host, executing a host application associated with a client application executing on the UE to receive the user data from the UE.

Embodiment 54. The method of the previous embodiment, further comprising:
at the host, transmitting input data to the client application executing on the UE, the input data being provided by executing the host application,
wherein the user data is provided by the client application in response to the input data from the host application.

Embodiment 55. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   determining (220) information about a cell of the communications network, the information indicating whether the cell is capable of providing timing related information;
   determining (240) to associate with the cell based on the information; and
   responsive to determining to associate with the cell, associating (250) with the cell.

Embodiment 56. The host of the previous embodiment, wherein the cellular network further includes a network node configured to communicate with the UE to transmit the user data from the UE to the host.

Embodiment 57. The host of the previous 2 embodiments, wherein:
the processing circuitry of the host is configured to execute a host application, thereby providing the user data; and
the host application is configured to interact with a client application executing on the UE, the client application being associated with the host application.

Embodiment 58. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
   determining (220) information about a cell of the communications network, the information indicating whether the cell is capable of providing timing related information;
   determining (240) to associate with the cell based on the information; and
   responsive to determining to associate with the cell, associating (250) with the cell.

Embodiment 59. The method of the previous embodiment, further comprising:
at the host, executing a host application associated with a client application executing on the UE to receive the user data from the UE.

Embodiment 60. The method of the previous embodiments, further comprising:
at the host, transmitting input data to the client application executing on the UE, the input data being provided by executing the host application,
wherein the user data is provided by the client application in response to the input data from the host application.

1. A method of operating a communication device in a communications network, the method comprising:
determining information about a cell of the communications network, the information indicating whether the cell is providing timing related information;
determining to associate with the cell based on the information; and
responsive to determining to associate with the cell, associating with the cell.

2. The method of claim 1, wherein associating with the cell comprises camping on the cell.

3. The method of claim 1, wherein determining to associate with the cell comprises determining to associate with the cell while the communication device is in a radio resource control, RRC, idle state or a RRC inactive state.

4. The method of claim 1, further comprising:
determining that the communication device is capable of using the timing related information based on at least one of:
a service that is active on the communication device;
a service that is available on the communication device;
a subscription associated with the communication device;
a capability of the communication device; and
configuration information provided by the communications network,
wherein determining the information comprises determining the information in response to determining that the communication device is capable of using the timing related information.

5. The method of claim 4, wherein determining that the communication device is capable of using the timing related information comprises determining an importance of using the timing related information, and
wherein determining to associate with the cell comprises determining to associate with the cell based on the importance of using the timing related information.

6. The method of claim 1, wherein the information further indicates an accuracy of the timing related information provided by the cell.

7. The method of claim 1, wherein the information comprises first information,
wherein the cell comprises a first cell,
the method further comprising:
determining second information about a second cell of the communications network, the second information indicating whether the second cell is providing timing related information,
wherein determining to associate with the first cell comprises determining to associate with the first cell rather than the second cell based on the first information and the second information.

8. The method of claim 7, wherein the first information comprises an indication that the first cell is providing the timing related information,
wherein the second information comprises an indication that the second cell is not providing the timing related information,
wherein determining to associate with the first cell rather than the second cell comprises determining to associate with the first cell rather than the second cell based on the first cell providing the timing related information and the second cell not providing the timing related information, and
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first cell providing the timing related information and the second cell not providing the timing related information;
determining that a difference between the second characteristic and the first characteristic is less than the threshold difference; and
determining to associate with the first cell rather than the second cell based on the difference being less than the threshold difference.

9. The method of claim 7, wherein the first information comprises an indication that the first cell is providing the timing related information,
wherein the second information comprises an indication that the second cell is not providing the timing related information, and
wherein determining to associate with the first cell rather than the second cell comprises determining to associate with the first cell rather than the second cell based on the first cell providing the timing related information and the second cell not providing the timing related information,
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first cell providing the timing related information and the second cell not providing the timing related information;
determining that a difference between the second characteristic and the first characteristic is less than the threshold difference; and
determining to associate with the first cell rather than the second cell based on the difference being less than the threshold difference.

10. The method of claim 7, wherein the first information comprises an indication of a first accuracy of timing related information provided by the first cell;
wherein the second information comprises an indication of a second accuracy of timing related information provided by the second cell;
wherein determining to associate with the first cell rather than the second cell comprises determining to associate with the first cell rather than the second cell based on the first accuracy being greater than the second accuracy,
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first accuracy and the second accuracy;
determining that a difference between the second characteristic and the first characteristic is less than the threshold difference; and
determining to associate with the first cell rather than the second cell based on the difference being less than the threshold difference.

11. The method of claim 7, wherein the first information comprises an indication that the first cell is not providing the timing related information,
wherein the second information comprises an indication that the second cell is providing the timing related information, and
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first cell not providing the timing related information and the second cell providing the timing related information;
determining that the difference between the second characteristic and the first characteristic is greater than the threshold difference; and
determining to associate with the first cell rather than the second cell based on the difference being greater than the threshold difference.

12. The method of claim 7, wherein the first information comprises an indication that the first cell is not providing the timing related information,
wherein the second information comprises an indication that the second cell is providing the timing related information, and
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first cell not providing the timing related information and the second cell providing the timing related information;
determining that the difference between the second characteristic and the first characteristic is greater than the threshold difference; and
determining to associate with the first cell rather than the second cell based on the difference being greater than the threshold difference.

13. The method of claim 7, wherein the first information comprises an indication of a first accuracy of timing related information provided by the first cell;
wherein the second information comprises an indication of a second accuracy of timing related information provided by the second cell, the second accuracy being greater than the first accuracy;
wherein determining to associate with the first cell rather than the second cell comprises:
determining a first characteristic of the first cell, the first characteristic being separate from the capability of the first cell to provide timing related information;
determining a second characteristic of the second cell, the second characteristic being separate from the capability of the second cell to provide timing related information;
determining a threshold difference based on the first accuracy and the second accuracy;
determining that the difference between the second characteristic and the first characteristic is greater than the threshold difference; and
determining to associate with the first cell rather than the second cell based on the difference being greater than the threshold difference.

14. The method of claim 7, wherein the first characteristic and the second characteristic each comprise at least one of:
a reference signal received quality, RSRQ, measurement;
a reference signal received power, RSRP, measurement; and
a signal-to-interference-to-noise, SINR, measurement, and
wherein determining the threshold difference further comprises determining the threshold difference based on an importance of using the timing related information to the communication device.

15. The method of claim 1, wherein determining the information about the cell comprises receiving the information from the cell via a broadcast channel or a system information block.

16. The method of claim 1, wherein determining the information about the cell comprises receiving the information from a neighboring cell to the cell.

17. The method of claim 1, wherein determining the information about the cell comprises determining the information based on a frequency used by the cell.

18. A method of operating a network node in a communications network, the method comprising:
determining information about a cell of the communications network, the information indicating whether the cell is providing timing related information; and
transmitting an indication of the information to a communication device.

19. The method of claim 18, wherein the network node is configured to provide at least one of:
the cell; and
a neighboring cell of the cell.

20. The method of claim 19, wherein the information further indicates an accuracy of the timing related information provided by the cell.

21-33. (canceled)
